(19) United States
(12) Patent Application Publication
(10) Pub. No.: US 2020/0058018 A1
(43) Pub. Date: Feb. 20, 2020

(54) FINANCIAL INVESTMENT ALGORITHM TRADING METHOD AND SYSTEM BASED ON BLOCKCHAIN SMART CONTRACT

(71) Applicant: Chao-Ming CHO, Taipei City (TW)

(72) Inventor: Chao-Ming CHO, Taipei City (TW)

(21) Appl. No.: 16/521,779

(22) Filed: Jul. 25, 2019

(30) Foreign Application Priority Data
Aug. 16, 2018 (TW) 107128687

(51) Int. Cl. G06Q 20/36; G06Q 40/04; G06Q 40/08

(52) U.S. Cl. CPC G06Q 20/3678; G06Q 2220/00; G06Q 40/08; G06Q 40/04

(57) ABSTRACT

The invention provides a financial investment application algorithm trading method and system based on a blockchain smart contract, applicable to a blockchain network executing the smart contract, comprising: an user interface program in an investment end, a financial investment application program in a generation end, a financial instrument trading center for trading various generation products, a smart trading gateway managing generation accounts, and a smart contract. The financial investment activities and profit sharing constructed on the invention is automated according to the smart contract, and the trading terms of agreement are immutable, and all the activities are actively collected in the blockchain for viewing, which are traceable, immutable and irreversible, and enable the investment end and the generation end to execute profit sharing according to the smart contract, effectively preventing any respective parties from not executing contract and avoiding the risk of financial fraud.

### CROSS-REFERENCE TO RELATED APPLICATION

This application claims the priority of Taiwanese patent application No. 107128687, filed on Aug. 16, 2018, which is incorporated herewith by reference.

### BACKGROUND OF THE INVENTION

### 1. Field of the Invention

The technical field generally relates to a financial investment application algorithm trading method and system, and in particular, to a financial investment application algorithm trading method and system based on a blockchain smart contract.

### 2. The Prior Arts

Financial investment and management is a topic that everyone in the world will be exposed to, and it is also an important issue for everyone in the future regarding retirement and or making a fortune. However, financial landmine and financial fraud will always be involved when the investment is concerned even for the banking system, and there have been occasional bank fraud scandals involving insiders. To pursue high profits, in addition to investment uncertain, investors sometimes may receive misleading information and even the false investment performance, resulting in great loss.

The tricks of financial fraud are basically the same. The bottom line is that the profit is manipulated by the people. By distributing the money chronologically, the investors perceive the illusion of profitability, or through the fake investment performance to con the investors, or fleeing with money through the breach of contract.

The key is that the fraud criminals are skilled in mastery of playing with human nature, especially for converting suspicious investors. When the investor is convinced by the logic of the fraud criminals, instead of using fair mechanisms, un-tampered data analysis and presentation, and correct execution of the contract, the investor is likely to fall into the trap.

Therefore, how to effectively solve the occurrence of fraudulent misconduct in financial investment and generation trading, and effectively verify the authenticity of the data security guaranteed to be unaltered, thus protecting the investor's property, is a goal for the industry to be achieved.

### SUMMARY OF THE INVENTION

The primary objective of the present invention is to provide a financial investment application algorithm trading method based on a blockchain smart contract.

To achieve the above objective, the present invention provides a financial investment application algorithm trading method based on a blockchain smart contract, which comprises the following steps:

An investment end generates and transmits a selection command to a cloud host platform through a user interface program, and selects the financial investment application program stored on the cloud host platform, therewith selects a financial investment application program of a generation end stored in the cloud host platform, the selected financial investment application program, according to the selection command, transmits a fixed remuneration investment agreement and/or a payment allocation investment agreement to a smart contract on a blockchain network, and the financial investment application program requests the smart contract to transmit the fixed remuneration investment agreement and/or the payment allocation investment agreement to the user interface program for displaying; the user interface program executes the displayed fixed remuneration investment agreement or the payment allocation investment agreement, or executes one of the displayed fixed remuneration investment agreement and the payment allocation investment agreement, the user interface program transmit a corresponding authorization command generated after execution to the smart contract to achieve mutual assent between the user interface program and the smart contract; the user interface program performs purchase of a first crypto currency matching a fixed remuneration generation charge stated in the fixed remuneration investment agreement according to the fixed remuneration generation charge stated in the fixed remuneration investment agreement, the user interface program stores the purchased first crypto currency to the smart contract to achieve provision of the fixed-investment investment agreement of the financial investment application program on the smart contract; the user interface program performs purchase of a second crypto currency matching a profit payment allocation generation charge stated in the payment allocation investment agreement as a warranty according to the profit payment allocation generation charge stated in the payment allocation investment agreement, the user interface program stores the second crypto currency purchased as the warranty to the smart contract to achieve provision of the payment allocation investment agreement of the financial investment application program on the smart contract; the smart contract activates to enable the financial investment application program and a smart trading gateway in response to the authorization command and completion of storing of the first crypto currency or the storing of the second crypto currency as the warranty; the user interface program transmits a computer interface data obtained from an account opened at a financial instruments trading center by the investment end to the smart trading gateway for storage; the smart trading gateway responds to a decision command from the financial investment application program of the generation end and uses the computer interface data to interface with the account opened at the financial instruments trading center, so as to issue an operation command of financial commodity at the financial instruments trading center, and the smart trading gateway can also receive financial investment performance data transmitted by the financial instruments trading center and can transmit financial investment performance data to the smart contract; and the smart contract receives the financial investment performance data transmitted by the smart trading gateway, regardless of the financial investment performance data, the smart contract will disburse the first crypto currency stored in the smart contract to the financial investment application program of the generation end based on the fixed remuneration investment agreement contracted between the user interface program and the financial investment application program; the smart contract receives the financial investment performance data transmitted by the smart trading gateway, and, the smart contract disburse a portion of the second crypto currency stored in the smart contract matching the financial investment performance data to the financial investment application program of the generation end based on the payment allocation investment agreement contracted between the user interface program and the financial investment application program.

Another objective of the present invention is to provide a financial investment application algorithm trading system based on a blockchain smart contract.

To achieve the above objective, the present invention provides a financial investment application algorithm trading system based on a blockchain smart contract, which comprises: an investment end, comprising a user interface program; a generation end, comprising a financial investment application program, and the financial investment application program being stored in a cloud host platform; a financial instruments trading center; a smart trading gateway, storing a computer interface data obtained by an account opened by the user interface program in the financial instruments trading center transmitted from the user interface program of the investment end; and a smart contract, written with a fixed remuneration investment agreement and/or a payment allocation investment agreement recorded in the financial investment application program; wherein, the investment end generates and transmits a selection command to a cloud host platform through the user interface program, and selects the financial investment application program stored on the cloud host platform, therewith selects the financial investment application program of the generation end stored in the cloud host platform, the selected financial investment application program, according to the selection command, transmits the fixed remuneration investment agreement and/or the payment allocation investment agreement to the smart contract on a blockchain network, and the financial investment application program requests the smart contract to transmit the fixed remuneration investment agreement and/or the payment allocation investment agreement to the user interface program for displaying; the user interface program executes the displayed fixed remuneration investment agreement or the payment allocation investment agreement, or executes one of the displayed fixed remuneration investment agreement and the payment allocation investment agreement, the user interface program transmit a corresponding authorization command generated after execution to the smart contract to achieve mutual assent between the user interface program and the smart contract; the user interface program performs purchase of a first crypto currency matching a fixed remuneration generation charge stated in the fixed remuneration investment agreement according to the fixed remuneration generation charge stated in the fixed remuneration investment agreement, the user interface program stores the purchased first crypto currency to the smart contract to achieve provision of the fixed-investment investment agreement of the financial investment application program on the smart contract; the user interface program performs purchase of a second crypto currency matching a profit payment allocation generation charge stated in the payment allocation investment agreement as a warranty according to the profit payment allocation generation charge stated in the payment allocation investment agreement, the user interface program stores the second crypto currency purchased as the warranty to the smart contract to achieve provision of the payment allocation investment agreement of the financial investment application program on the smart contract; the smart contract activates to enable the financial investment application program and the smart trading gateway in response to the authorization command and completion of storing of the first crypto currency or the storing of the second crypto currency as the warranty; the user interface program transmits the computer interface data obtained from the account opened at the financial instruments trading center by the investment end to the smart trading gateway for storage; the smart trading gateway responds to a decision command from the financial investment application program of the generation end and uses the computer interface data stored therein to interface with the account opened at the financial instruments trading center, so as to issue an operation command of financial commodity at the financial instruments trading center, and the smart trading gateway can also receive financial investment performance data transmitted by the financial instruments trading center and can transmit financial investment performance data to the smart contract; and the smart contract receives the financial investment performance data transmitted by the smart trading gateway, regardless of the financial investment performance data, the smart contract will disburse the first crypto currency stored in the smart contract to the financial investment application program of the generation end based on the fixed remuneration investment agreement contracted between the user interface program and the financial investment application program; the smart contract receives the financial investment performance data transmitted by the smart trading gateway, and, the smart contract disburse a portion of the second crypto currency stored in the smart contract matching the financial investment performance data to the financial investment application program of the generation end based on the payment allocation investment agreement contracted between the user interface program and the financial investment application program.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1A and FIG. 1B show a schematic view of the flowchart of the financial investment application algorithm trading method based on a blockchain smart contract of the present invention;

FIG. 2 shows a schematic view of the financial investment application algorithm trading system based on the blockchain smart contract of the present invention;

FIG. 3 shows another schematic view of the financial investment application algorithm trading system based on the blockchain smart contract of the present invention; and

FIG. 4 shows yet another schematic view of the financial investment application algorithm trading system based on a blockchain smart contract of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

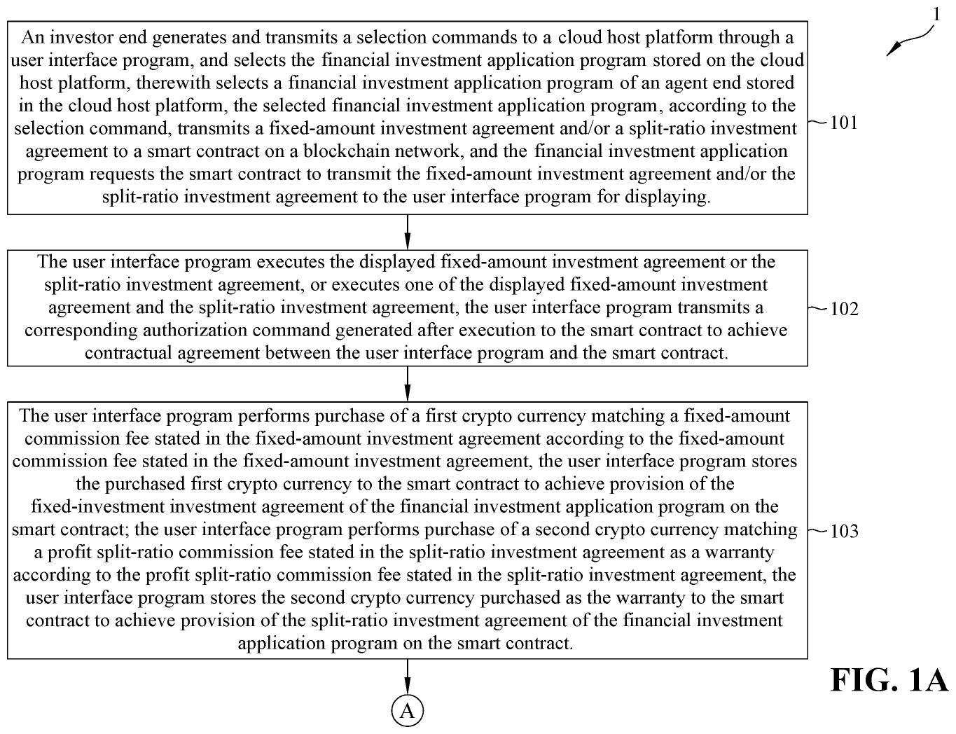

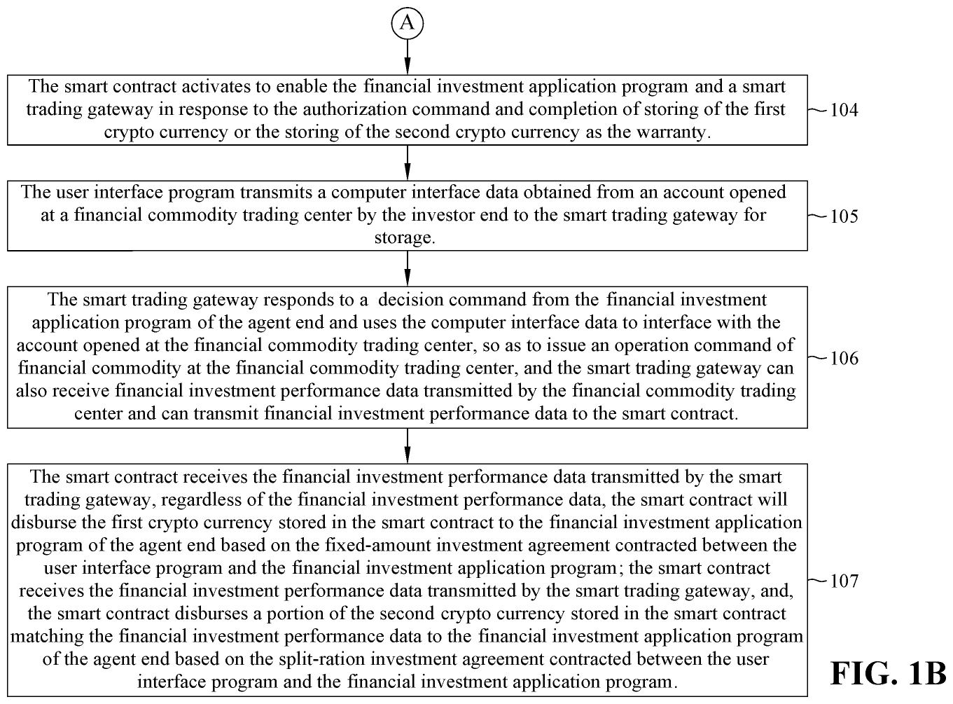

FIG. 1A and FIG. 1B show a schematic view of the flowchart of the financial investment application algorithm trading method based on a blockchain smart contract of the present invention. For description convenience, the financial investment application algorithm trading method based on the blockchain smart contract is referred to as method 1 thereafter, wherein method 1 comprises steps 101, 102, 103, 104, 105, 106, and 107.

Moreover, as used in the scope of the patent application, the term “a” can mean one or a plural group. That is to say, the “a” mentioned in the scope of the patent application is not limited to one, and may include one or more (that is, plural). For example, an investment end or a user interface program described in claim 1 of the patent application means that the investment end can be one or more; the user interface program can be one or more.

Step 101: an investment end generates and transmits a selection command to a cloud host platform through a user interface program, and selects the financial investment application program stored on the cloud host platform, therewith selects a financial investment application program of a generation end stored in the cloud host platform, the selected financial investment application program, according to the selection command, transmits a fixed remuneration investment agreement and/or a payment allocation investment agreement to a smart contract on a blockchain network, and the financial investment application program requests the smart contract to transmit the fixed remuneration investment agreement and/or the payment allocation investment agreement to the user interface program for displaying.

Therein, the user interface program can be implanted in mobile electronic devices, including but not limited to smart phones, notebook computers; or fixed electronic devices, including but not limited to desktop computers. The investment end then uses the user interface program to access the financial investment application program stored on a remote cloud host platform. The investment end can freely select the financial investment that meets the needs thereon according to the investment agreement stated in one or more financial investment application programs, wherein the investment agreement can record the past investment performance of the financial investment application program, the operator whose logic that the financial investment application program is based on, various caution notes of the financial investment, and related payment and disbursement, profit-sharing, and so on.

The smart contracts, in short, are a special protocol used in blockchain in the development of contracts, primarily to provide verification and execution of the conditions and terms defined in the smart contracts. In addition, smart contracts are defined by the creator and constructed by blockchain network execution, wherein all messages related to the contract conditions and terms are automatically executed according to the actions set in the contract.

The financial investment application program is an artificial intelligence (AI) program, an experience logic program, a transaction logic program, a mathematical model based program or any combination thereof.

The financial investment application program is active. That is, the user interface program of the investment end does not need to judge the investment logic, and only needs to decide which financial investment application program to appoint, whether to continue or whether to liquidate, and so on. All investment logic judgments are made by the financial investment application program actively and automatically.

After the investment end finishes selection, the user interface program will generate the selection command and transmit to the remote cloud host platform, thereby selecting the financial investment application program of the generation end stored on the cloud host platform. In response to the selection command, the financial investment application program will transmit the fixed remuneration investment agreement and/or the payment allocation investment agreement stated on the financial investment application program to the smart contract on the blockchain network. The financial investment application program will request the smart contract to transmit the fixed remuneration investment agreement and/or the payment allocation investment agreement to the user interface program for displaying.

The so-called fixed remuneration investment agreement refers to paying only a fixed amount as the agency expense regardless that the future investment is a profit or a loss, and; and in the payment allocation investment agreement, the payment as the agency expense is based on the actual performance of the operation, i.e., an agreed proportion of the profit.

The generation end determines whether the financial investment application program provides only a fixed remuneration investment agreement or an investment-only investment agreement, or both.

Step 102: the user interface program executes the displayed fixed remuneration investment agreement or the payment allocation investment agreement, or executes one of the displayed fixed remuneration investment agreement and the payment allocation investment agreement, the user interface program transmit a corresponding authorization command generated after execution to the smart contract to achieve mutual assent between the user interface program and the smart contract.

Wherein, if the financial investment application program only provides the fixed remuneration investment agreement, the user interface program only needs to execute the fixed remuneration investment agreement displayed thereon; if the financial investment application program only provides the payment allocation investment agreement, the user interface program only needs to execute the payment allocation investment agreement displayed thereon; if the financial investment application program provides both for selection, the user interface program needs to select one of the fixed remuneration investment agreement or the payment allocation investment agreement displayed thereon. After execution, the user interface program will generate the authorization command corresponding to the selected investment agreement, and the authorization command will be transmitted to the smart contract to achieve mutual assent between the user interface program and the smart contract, i.e., the intended contract is signed.

Step 103: the user interface program performs purchase of a first crypto currency matching a fixed remuneration generation charge stated in the fixed remuneration investment agreement according to the fixed remuneration generation charge stated in the fixed remuneration investment agreement, the user interface program stores the purchased first crypto currency to the smart contract to achieve provision of the fixed-investment investment agreement of the financial investment application program on the smart contract; the user interface program performs purchase of a second crypto currency matching a profit payment allocation generation charge stated in the payment allocation investment agreement as a warranty according to the profit payment allocation generation charge stated in the payment allocation investment agreement, the user interface program stores the second crypto currency purchased as the warranty to the smart contract to achieve provision of the payment allocation investment agreement of the financial investment application program on the smart contract.

As described in step 102, after the user interface program and the smart contract achieve mutual assent, the user interface program will pay the fee as generation charge according to the content of the smart contract.

If the user interface program is to execute a fixed remuneration investment agreement, then the user interface program must purchase the first crypto currency of an agreed fixed remuneration of the generation charge according to the agreed fixed remuneration stated in the fixed remuneration investment agreement. After the purchase of the first crypto currency of the agreed fixed remuneration of the generation charge, the user interface program stores the purchased first crypto currency to the smart contract, thereby achieving the provisions of the fixed remuneration investment agreement of the financial investment application program on the smart contract.

It should be explained that the so-called fixed remuneration investment agreement means that the smart contract signed by the investment end and the generation end is a fixed remuneration, regardless of the actual investment performance, whether the actual performance is higher or lower than the agreed performance, the user interface program of the investment end only needs to pay a fixed remuneration to the financial investment application program of the generation end.

For example, a fixed remuneration investment agreement states that the past investment performance of the financial investment application program can reach an annualized rate of return of 500%, and the required generation remuneration for the generation end is 50% of the principal invested by the investment end. Therefore, 50% of the principal must be paid in the first crypto currency. If the principal is NT$1,000,000, this means that the user interface program must purchase the first crypto currency equivalent to NT$500,000 as payment for the generation remuneration. In the future, regardless that the financial investment application program helps the investment end to earn more or less than NT$500,000, the user interface program of the investment end does not need to pay any generation remuneration. The financial investment application program of the generation end will not return any proportion of the generation remuneration.

It should also be noted that the first crypto currency includes, but not limited to, a crypto currency issued by the information service provider of the present invention, which may also be a crypto currency already existing on the market, including, but not limited to, Bitcoin and Ethereum, Ripple, Litecoin, and so on.

The first crypto currency may be a stable crypto currency with a stable price, such as a Tether USDT that follows the US dollar value or even a currency that follows the currency of other countries; or a volatile crypto currency with possible a price fluctuation, for example, the aforementioned Bitcoin, Ethereum, Ripple, Litecoin, and so on.

In addition, regarding the purchase of the first crypto currency, in more detail, the user interface program can be connected to a vendor platform that provides the information service of the present invention, and purchases the crypto currency issued by the manufacturer and stores or temporarily stores a crypto currency wallet software unit stored on the user interface program.

Alternatively, the user interface program may be connected to any particular crypto currency service provider, dealer, transaction center to purchase directly, or transfer the first crypto currency that has already been purchased in advance. The purchased and stored or temporarily stored first crypto currency in the crypto currency wallet software unit of the user interface program can also be stored to the smart contract.

In addition, in more detail, if the user interface program is to execute the payment allocation investment agreement, the user interface program must purchase the second crypto currency of an agreed generation charge determined by a ratio of the profit stated in the payment allocation investment agreement used as the warranty. After the user interface program purchases the second crypto currency of the agreed generation charge determined by the profit ratio, the user interface program stores the purchased second crypto currency used as a warranty, to the smart contract to achieve the agreed terms of the financial investment application program on the smart contract.

Similarly, the second crypto currency purchased by the user interface program may be stored or temporarily stored on the crypto currency wallet software unit of the user interface program.

It should be explained that the so-called payment allocation investment agreement refers to the fact that the smart contract signed by the investment end and the generation end is to pay the generation charge based on the actual performance of the investment. The better the performance is, the higher the generation charge. That is to say, the user interface program of the investment end will pay different amounts of generation charge according to the performance achieved by the financial investment application program.

For example, the payment allocation investment agreement shows that the past investment performance of the financial investment application program can reach an annualized rate of return of 500%, and the required generation remuneration can be agreed in a stepwise manner according to the performance of the investment. A possible agreement on the generation charge can be set as follows: if the performance of the investment is 100% of the profit in three months, then 50% of the profit will be paid to the financial investment application program; if the performance is to achieve 50% of the profit within three months, then 30% of the profit will be paid to the financial investment application program; if the performance does not reach 20% of the profit within three months, then there will be no payment as generation charge to the financial investment application program.

Wherein, the user interface program is required to store the first crypto currency or the second crypto currency in the smart contract in advance, so as to ensure that the financial investment application program can automatically obtain the due generation remuneration when the agreement is reached according to the smart contract. There will be no need to worry that the generation end will not receive the payment from the investment end because the breach of the contract by the user interface program.

Accordingly, for the payment allocation investment agreement, the present invention requires the user interface program to store in advance the agreed maximum profit ratio in the second crypto currency to the smart contract, in this case, 50% of the profit.

More specifically, if the principal of the agent is NT$1,000,000, and if the performance of the investment is 100% of the profit in three months, then 50% of the profit will be paid to the financial investment application program, this means that the user interface program must purchase a second crypto currency equivalent to NT$500,000 as a warranty to be stored on the smart contract. If the 100% profit is successfully achieved in the next three months, the second crypto currency equivalent of NT$500,000 will be automatically paid to the financial investment application program in full through the smart contract; if it exceeds 100% of the profit, the user interface program will be notified whether to settle or replenish the warranty to continue the financial investment application program to ensure that the financial investment application program obtains deserved generation remuneration. If only 50% of the profit is achieved in the next three months, the financial investment application program only earns NT$500,000 in three months, and only 30% of the NT$500,000 (the profit) will be paid according to the smart contract, that is, NT$150,000. Then, the warranty of the pre-existing second crypto currency equivalent to NT$500,000 (the warranty is pre-stored with the highest paid profit) will be paid only through the smart contract the value of NT$150,000 in the second crypto currency to the financial investment application program.

Wherein, regarding the amount of the warranty is paid, if the warranty stored on the smart contract is lower than the insurance level, the smart contract will transmit the warranty payment message to the user interface program, and the user interface program must purchase the second crypto currency enough to make up to the agreed generation charge determined by a ratio of the profit stated in the payment allocation investment agreement used as the warranty to meet the warranty requirements, and then the smart contract will continue.

On the other hand, if the user interface program does not purchase the second crypto currency enough to make up to the agreed generation charge determined by a ratio of the profit stated in the payment allocation investment agreement used as the warranty, the smart contract will be liquidated.

It should be noted that the second crypto currency includes, but not limited to, a crypto currency issued by the information service provider of the present invention, which may also be a crypto currency already existing on the market, including, but not limited to, Bitcoin and Ethereum, Ripple, Litecoin, and so on.

The second crypto currency may be a stable crypto currency with a stable price, such as a Tether USDT that follows the US dollar value or even a currency that follows the currency of other countries; or a volatile crypto currency with possible a price fluctuation, for example, the aforementioned Bitcoin, Ethereum, Ripple, Litecoin, and so on.

In addition, regarding the purchase of the second crypto currency, in more detail, the user interface program can be connected to a vendor platform that provides the information service of the present invention, and purchases the crypto currency issued by the manufacturer and stores or temporarily stores a crypto currency wallet software unit stored on the user interface program.

Alternatively, the user interface program may be connected to any particular crypto currency service provider, dealer, and transaction center to purchase directly, or transfer the second crypto currency that has already been purchased in advance. The purchased and stored or temporarily stored second crypto currency in the crypto currency wallet software unit of the user interface program can also be stored to the smart contract.

Step 104: the smart contract activates to enable the financial investment application program and a smart trading gateway in response to the authorization command and completion of storing of the first crypto currency or the storing of the second crypto currency as the warranty.

In step 104, when the smart contract responds to the authorization command, that is, when the smart contract receives the authorization command and agrees to sign the contract with the user interface program, and the first crypto currency or the second crypto currency as the warranty meets the amount required for the contract is stored, the smart contract will be launched to enable financial investment application programs and smart trading gateway, i.e., start the financial investment application program and smart trading gateway.

Step 105: the user interface program transmits a computer interface data obtained from an account opened at a financial instruments trading center by the investment end to the smart trading gateway for storage.

Wherein the computer interface data includes, but not limited to, account data, password data, and/or verification data used by Application Programming Interface (API).

To perform financial investment on behalf of the user interface program of the investment end, the financial investment application program of the generation end is bound to be connected to the computer based on the computer interface data of the account opened in the financial instruments trading center stored on the smart trading gateway, such as, account information, password information, and/or verification data used by API for subsequent operations.

The account data and password data are used for logging in to the account of the investment end; and the verification data used by API is for the account to provide to the smart trading gateway to connect to accounts of the investment end (where number of accounts can be one or more for data access, automated program transactions, and so on.

It is worth noting that the computer interface data of one or more accounts opened by the investment end in the financial instruments trading center is stored in the smart trading gateway instead of being stored in the financial investment application program. The purpose is to avoid fraud by not allowing the financial investment application program to access the relevant account information of the investment end, and the financial investment application program only needs to provide the trading logic of investment agent, thus preventing the financial investment application program from being fraudulently.

Wherein, the financial instruments trading center is a center where a variety of dealers with which the various investment ends have opened the account, and is used to connect the financial investment application program of the generation end to exchange various financial products, including, but not limited to, crypto currency trading centers, stock exchange centers, futures commodity trading centers, financial foreign exchange trading companies, commodity trading financial centers, real estate trading centers, movable property trading centers, derivative commodity trading centers or hedge commodity trading centers.

Step 106: the smart trading gateway responds to a decision command from the financial investment application program of the generation end and uses the computer interface data to interface with the account opened at the financial instruments trading center, so as to issue an operation command of financial commodity at the financial instruments trading center, and the smart trading gateway can also receive financial investment performance data transmitted by the financial instruments trading center and can transmit financial investment performance data to the smart contract.

It should be noted that the smart trading gateway can interface with one or more investor accounts. When more than one investor account is connected, the financial investment application program can execute more flexible operations on one or more investor accounts, including but not limited to arbitrage trading, hedging transactions, and so on.

Wherein, the smart trading gateway can be regarded as a virtual agent program, which coexists with the financial investment application program, and the financial investment application program must collaborate with the smart trading gateway to safely and smoothly execute the financial investment transactions on the blockchain.

The role of the smart trading gateway is similar to that of the channel. The computer interface data of the account opened in the financial instruments trading center will be stored here, and will not be stored in the financial investment application program. The purpose is for security control. However, if the computer interface data of the investment end is stored in the financial investment application program, the financial investment application program may be able to conduct fraud.

In other words, the financial investment application program will only be responsible for the investment logic of the agent, similar to a brain center; and the smart trading gateway is responsible for the execution of the order, data access and other actions.

It is worth noting that the collaboration also includes the combination of the financial investment application program and the number of smart trading gateways. If a financial investment application program has 10 user interface programs that want to entrust to invest in the operation, then the number of smart trading gates must be 10; if there are 10 different financial investment application programs, and each financial investment application program has 100 user interface programs that want to entrust to invest in the operation, then the overall number of smart trading gateways on the blockchain smart contract structure must be 1,000.

Step 107: the smart contract receives the financial investment performance data transmitted by the smart trading gateway, regardless of the financial investment performance data, the smart contract will disburse the first crypto currency stored in the smart contract to the financial investment application program of the generation end based on the fixed remuneration investment agreement contracted between the user interface program and the financial investment application program; or, the smart contract receives the financial investment performance data transmitted by the smart trading gateway, and, the smart contract disburses a portion of the second crypto currency stored in the smart contract matching the financial investment performance data to the financial investment application program of the generation end based on the payment allocation investment agreement contracted between the user interface program and the financial investment application program.

Step 107 describes the way of profit sharing between the investment end and the generation end. If the smart contract between the user interface program of the investment end and the financial investment application program of the generation end is signed with a fixed remuneration investment agreement, regardless of the performance of the financial investment application program, the smart contract will pay the first crypto currency stored on the smart contract to the financial investment application program of the generation end according to the content of the smart contract signed with the user interface program.

If the smart contract between the user interface program of the investment end and the financial investment application program of the generation end is signed with a payment allocation investment agreement, the smart contract will pay a ratio of the second crypto currency stored on the smart contract to the financial investment application program of the generation end according to the content of the smart contract signed with the user interface program and according to the performance of the financial investment application program.

It is worth noting that the cloud host platform can obtain an agreed portion of the first crypto currency or the second crypto currency obtained by the financial investment application program through the financial investment application programs on the shelf of the cloud host platform as a profit (or service charge) of the information service provider implementing the method 1 of the present invention.

For example, if the financial investment application program obtains the first crypto currency equivalent to NT$500,000 as the generation remuneration, the cloud host platform is about to direct the financial investment application program to extract 5% of the generation remuneration. As a profit, the financial investment application program will allow the cloud host platform to extract the first crypto currency of the equivalent of NT$25,000 as a profit for implementing the method 1 of the present invention including the cloud host platform as an information service provider.

In the same way, if the financial investment application program obtains the second crypto currency equivalent to NT$500,000 as the generation remuneration, the cloud host platform is about to obtain 5% of the generation remuneration paid to the financial investment application program by the user interface program. Therefore, the financial investment application program will allow the cloud host platform to extract a second crypto currency equivalent to NT$25,000 as a profit for implementing the method 1 of the present invention including the cloud host platform as an information service provider.

Since the financial investment performance data transmitted by the smart contract in response to the smart trading gateway can be retransmitted to and displayed on the user interface program for the investment end to consult, the investment end can use the financial investment performance data at any time to make the user interface program to generate and transmit a transaction liquidation command to the smart contract requesting the smart contract to suspend the transaction for liquidation of the smart contract.

That is to say, the investment end can know the investment performance exhibited by the financial investment application program so far through the user interface program, and can generate and transmit the transaction liquidation command at any time to stop further trading or stop the loss.

The method 1 of the present invention is based on the architecture of the blockchain smart contract, so all financial investment behaviors, agent activity, and profit sharings constructed in the method 1 will be automated according to the contract content recorded on the smart contract. The trading terms of agreement of the contract can be immutable. All actions are also recorded in the blockchain for query, and will be traceable, immutable and irreversible, which will make the investment end the generation end always implement the distribution of benefits according to the smart contract, and effectively eliminate the risk of any party reluctant to follow the contract.

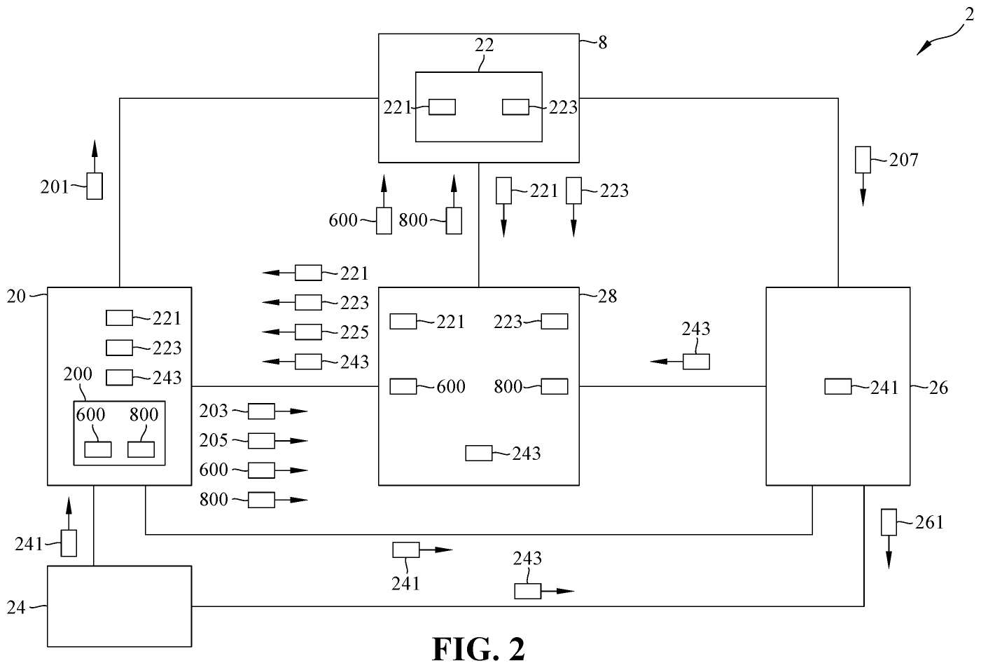

FIG. 2 shows a schematic view of the financial investment application algorithm trading system 2 based on blockchain smart contract of the present invention. The system is applicable to a blockchain network executing smart contract, which comprises: a user interface program 20 of the investment end, a financial investment application program 22 of the generation end, a financial instruments trading center 24, a smart trading gateway 26 and a smart contract 28.

The following describes each component of the system 2 in details:

an investment end, comprising a user interface program 20;

a generation end, comprising a financial investment application program 22, and the financial investment application program 22 being stored in a cloud host platform 8;

Therein, the user interface program 20 can be implanted in mobile electronic devices, including but not limited to smart phones, notebook computers; or fixed electronic devices, including but not limited to desktop computers. The investment end then uses the user interface program 20 to access the financial investment application program 22 stored on the remote cloud host platform 8. The investment end can freely select the financial investment that meets the needs thereon according to the investment agreement stated in one or more financial investment application programs 22, wherein the investment agreement can record the past investment performance of the financial investment application program 22, the operator whose logic that the financial investment application program is based on, various caution notes of the financial investment, and related payment and disbursement, profit-sharing, and so on.

The financial investment application program 22 is an artificial intelligence (AI) program, experience logic program, transaction logic program, mathematical model based program or any combination thereof.

The financial investment application program 22 is active. That is, the user interface program 20 of the investment end does not need to judge the investment logic, and only needs to decide which financial investment application program 22 to appoint, whether to continue or whether to liquidate, and so on. All investment logic judgments are made by the financial investment application program 22 actively and automatically.

a financial instruments trading center 24; wherein the financial instruments trading center 24 is a center where a variety of dealers with which the various investment ends have opened the account, and is used to connect the financial investment application program 22 of the generation end to exchange various financial products, including, but not limited to, crypto currency trading centers, stock exchange centers, futures commodity trading centers, financial foreign exchange trading companies, commodity trading financial centers, real estate trading centers, movable property trading centers, derivative commodity trading centers or hedge commodity trading centers.

a smart trading gateway 26, storing a computer interface data 241 obtained by an account opened by the user interface program 20 in the financial instruments trading center 24 transmitted from the user interface program 20 of the investment end; the computer interface data 241 comprising, but not limited to, account data, password data, and/or verification data used by API.

The purpose of the user interface program 20 transmits the computer interface data 241 to the smart trading gateway 26 is to enable the financial investment application program 22 to collaborate with the smart trading gateway 26 to interface to enter the account of opened by the investment end at the financial instruments trading center 24 (wherein the number of accounts can be one or more) to assist operating on behalf of the investment end.

To perform financial investment on behalf of the user interface program 20 of the investment end, the financial investment application program 22 of the generation end is bound to be connected to the computer based on the computer interface data 241 of the account opened in the financial instruments trading center 24 stored on the smart trading gateway 26, such as, account information, password information, and/or verification data used by API for subsequent operations.

The account data and password data are used for logging in to the account of the investment end; and the verification data used by API is for the account to provide to the smart trading gateway 26 to connect to one or more accounts of the investment end for data access, automated program transactions, and so on.

It is worth noting that the computer interface data 241 of one or more accounts opened by the investment end in the financial instruments trading center 24 is stored in the smart trading gateway 26 instead of being stored in the financial investment application program 22. The purpose is to avoid fraud by not allowing the financial investment application program 22 to access the relevant account information of the investment end, and the financial investment application program 22 only needs to provide the trading logic of investment agent, thus preventing the financial investment application program 22 from being fraudulently.

A smart contract 28, is written with a fixed remuneration investment agreement 221 and/or a payment allocation investment agreement 223 recorded in the financial investment application program 22.

The smart contracts 28, in short, are a special protocol used in blockchain in the development of contracts, primarily to provide verification and execution of the conditions and terms defined in the smart contracts 28. In addition, smart contracts 28 are defined by the creator and constructed by blockchain network execution, wherein all messages related to the contract conditions and terms are automatically executed according to the actions set in the contract.

Wherein, the investment end generates and transmits a selection commands 201 to the cloud host platform 8 through the user interface program 20, and selects the financial investment application program 22 stored on the cloud host platform 8, therewith selects the financial investment application program 22 of the generation end stored in the cloud host platform 8, the selected financial investment application program 22, according to the selection command 201, transmits the fixed remuneration investment agreement 221 and/or the payment allocation investment agreement 223 to the smart contract 28 on a blockchain network, and the financial investment application program 22 requests the smart contract 28 to transmit the fixed remuneration investment agreement 221 and/or the payment allocation investment agreement 223 to the user interface program 20 for displaying.

The so-called fixed remuneration investment agreement 221 refers to paying only a fixed amount as the agency expense regardless that the future investment is a profit or a loss, and; and in the payment allocation investment agreement 223, the payment as the agency expense is based on the actual performance of the operation, i.e., an agreed proportion of the profit.

The generation end determines whether the financial investment application program provides only a fixed remuneration investment agreement 221 or an investment-only investment agreement 223, or both.

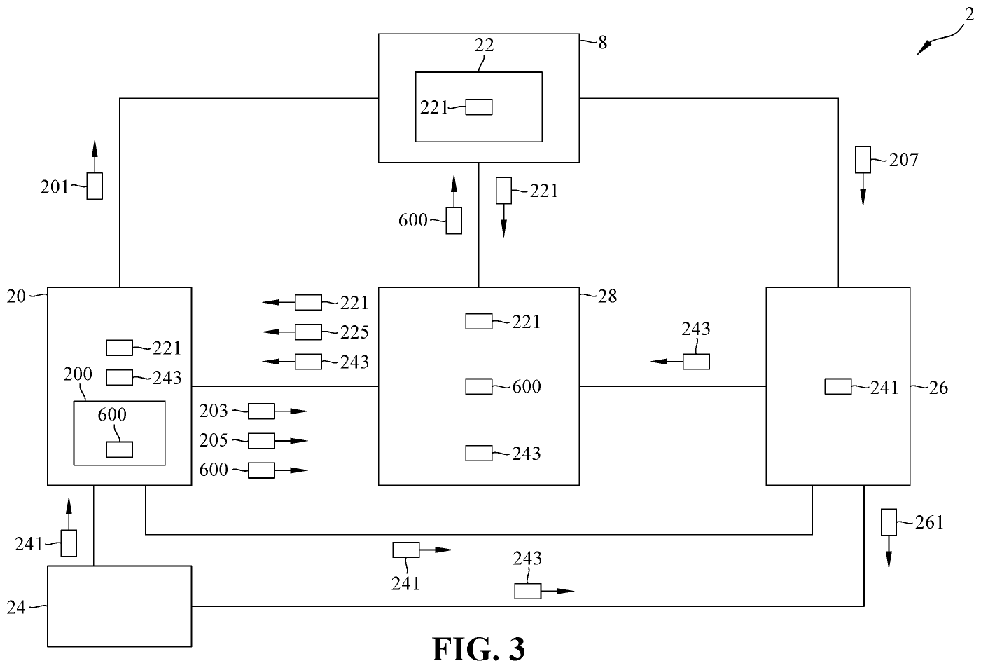

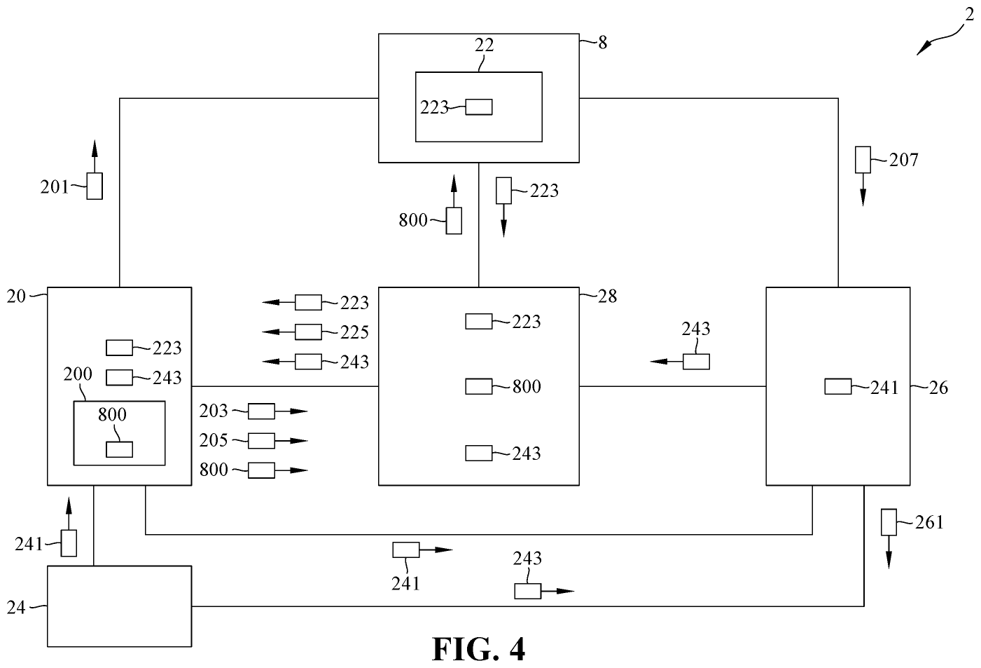

The user interface program 20 executes the displayed fixed remuneration investment agreement 221 or the payment allocation investment agreement 223, or executes one of the displayed fixed remuneration investment agreement 221 and the payment allocation investment agreement 223, the user interface program 20 transmit a corresponding authorization command 203 generated after execution to the smart contract 28 to achieve mutual assent between the user interface program 20 and the smart contract 28.

Wherein, if the financial investment application program 22 only provides the fixed remuneration investment agreement 221, the user interface program 20 only needs to execute the fixed remuneration investment agreement 221 displayed thereon (refer to FIG. 3); if the financial investment application program 22 only provides the payment allocation investment agreement 223, the user interface program 20 only needs to execute the payment allocation investment agreement 223 displayed thereon (refer to FIG. 4); if the financial investment application program 22 provides both for selection, the user interface program 20 needs to select one of the fixed remuneration investment agreement 221 or the payment allocation investment agreement 223 displayed thereon. After execution, the user interface program 20 will generate the authorization command 203 corresponding to the selected investment agreement, and the authorization command 203 will be transmitted to the smart contract 28 to achieve mutual assent between the user interface program 20 and the smart contract 28, i.e., the intended contract is signed.

The user interface program 20 performs purchase of a first crypto currency 600 matching a fixed remuneration generation charge stated in the fixed remuneration investment agreement 221 according to the fixed remuneration generation charge stated in the fixed remuneration investment agreement 221, the user interface program 20 stores the purchased first crypto currency 600 to the smart contract 28 to achieve provision of the fixed-investment investment agreement 221 of the financial investment application program 22 on the smart contract 28; the user interface program 20 performs purchase of a second crypto currency 800 matching a profit payment allocation generation charge stated in the payment allocation investment agreement 223 as a warranty according to the profit payment allocation generation charge stated in the payment allocation investment agreement 223, the user interface program 20 stores the second crypto currency 800 purchased as the warranty to the smart contract 28 to achieve provision of the payment allocation investment agreement 223 of the financial investment application program 22 on the smart contract 28.

After the user interface program 20 and the smart contract 28 achieve mutual assent, the user interface program 20 will pay the fee as generation charge according to the content of the smart contract 28.

If the user interface program 20 is to execute a fixed remuneration investment agreement 221, then the user interface program 20 must purchase the first crypto currency 600 of an agreed fixed remuneration of the generation charge according to the agreed fixed remuneration stated in the fixed remuneration investment agreement 221. After the purchase of the first crypto currency 600 of the agreed fixed remuneration of the generation charge, the user interface program 20 stores the purchased first crypto currency 600 to the smart contract 28, thereby achieving the provisions of the fixed remuneration investment agreement 221 of the financial investment application program 22 on the smart contract 28.

It should be explained that the so-called fixed remuneration investment agreement 221 means that the smart contract 28 signed by the investment end and the generation end is a fixed generation remuneration, regardless of the actual investment performance, whether the actual performance is higher or lower than the agreed performance, the user interface program 20 of the investment end only needs to pay a fixed generation remuneration to the financial investment application program 22 of the generation end.

For example, a fixed remuneration investment agreement 221 states that the past investment performance of the financial investment application program 22 can reach an annualized rate of return of 500%, and the required generation remuneration for the generation end is 50% of the principal invested by the investment end. Therefore, 50% of the principal must be paid in the first crypto currency 600. If the principal is NT$1,000,000, this means that the user interface program 20 must purchase the first crypto currency 600 equivalent to NT$500,000 as payment for the generation remuneration. In the future, regardless that the financial investment application program helps the investment end to earn more or less than NT$500,000, the user interface program 20 of the investment end does not need to pay any generation remuneration. The financial investment application program 22 of the generation end will not return any proportion of the generation remuneration.

It should also be noted that the first crypto currency 600 includes, but not limited to, a crypto currency issued by the information service provider of the present invention, which may also be a crypto currency already existing on the market, including, but not limited to, Bitcoin and Ethereum, Ripple, Litecoin, and so on.

The first crypto currency 600 may be a stable crypto currency with a stable price, such as a Tether USDT that follows the US dollar value or even a currency that follows the currency of other countries; or a volatile crypto currency with possible a price fluctuation, for example, the aforementioned Bitcoin, Ethereum, Ripple, Litecoin, and so on.

In addition, regarding the purchase of the first crypto currency 600, in more detail, the user interface program 20 can be connected to a vendor platform that provides the information service of the present invention, and purchases the crypto currency issued by the manufacturer and stores or temporarily stores a crypto currency wallet software unit stored on the user interface program 20.

Alternatively, the user interface program 20 may be connected to any particular crypto currency service provider, dealer, transaction center to purchase directly, or transfer the first crypto currency 600 that has already been purchased in advance. The purchased and stored or temporarily stored first crypto currency 600 in the crypto currency wallet software unit of the user interface program 20 can also be stored to the smart contract 28.

In addition, in more detail, if the user interface program 20 is to execute the payment allocation investment agreement 223, the user interface program 20 must purchase the second crypto currency 800 of an agreed generation charge determined by a ratio of the profit stated in the payment allocation investment agreement 223 used as the warranty. After the user interface program 20 purchases the second crypto currency 800 of the agreed generation charge determined by the profit ratio, the user interface program 20 stores the purchased second crypto currency 800 used as a warranty, to the smart contract 28 to achieve the agreed terms of the financial investment application program 22 on the smart contract 28.

Similarly, the second crypto currency 800 purchased by the user interface program 20 may be stored or temporarily stored on the crypto currency wallet software unit of the user interface program 20.

It should be explained that the so-called payment allocation investment agreement 223 refers to the fact that the smart contract 28 signed by the investment end and the generation end is to pay the generation charge based on the actual performance of the investment. The better the performance is, the higher the generation charge. That is to say, the user interface program 20 of the investment end will pay different amounts of generation charge according to the performance achieved by the financial investment application program 22.

For example, the payment allocation investment agreement 223 shows that the past investment performance of the financial investment application program 22 can reach an annualized rate of return of 500%, and the required generation remuneration can be agreed in a stepwise manner according to the generation performance of the investment. A possible agreement on the generation remuneration can be set as follows: if the generation performance of the investment is 100% of the profit in three months, then 50% of the profit will be paid to the financial investment application program 22; if the performance is to achieve 50% of the profit within three months, then 30% of the profit will be paid to the financial investment application program 22; if the performance does not reach 20% of the profit within three months, then there will be no payment as generation charge to the financial investment application program 22.

Wherein, the user interface program 20 is required to store the first crypto currency 600 or the second crypto currency 800 in the smart contract 28 in advance, so as to ensure that the financial investment application program 22 can automatically obtain the due generation remuneration when the agreement is reached according to the smart contract 28. There will be no need to worry that the generation end will not receive the payment of the generation remuneration from the investment end because the breach of the contract by the user interface program 20.

Accordingly, for the payment allocation investment agreement 223, the present invention requires the user interface program 20 to store in advance the agreed maximum profit ratio in the second crypto currency 800 to the smart contract 28, in this case, 50% of the profit.

More specifically, if the principal of the agent is NT$1,000,000, and if the performance of the investment is 100% of the profit in three months, then 50% of the profit will be paid to the financial investment application program 22, this means that the user interface program 20 must purchase a second crypto currency 800 equivalent to NT$500,000 as a warranty to be stored on the smart contract 28. If the 100% profit is successfully achieved in the next three months, the second crypto currency 800 equivalent of NT$500,000 will be automatically paid to the financial investment application program 22 in full through the smart contract 28; if it exceeds 100% of the profit, the user interface program 20 will be notified whether to settle or replenish the warranty to continue the financial investment application program to ensure that the financial investment application program 22 obtains the deserved generation remuneration. If only 50% of the profit is achieved in the next three months, the financial investment application program 22 only earns NT$500,000 in three months, and only 30% of the NT$500,000 (the profit) will be paid according to the smart contract, that is, NT$150,000. Then, the warranty of the pre-existing second crypto currency 800 equivalent to NT$500,000 (the warranty is pre-stored with the highest paid profit) will be paid only through the smart contract 22 the value of NT$150,000 in the second crypto currency 800 to the financial investment application program 22.

Wherein, regarding the amount of the warranty is paid, if the warranty stored on the smart contract 28 is lower than the insurance level, the smart contract 28 will transmit the warranty payment message to the user interface program 20, and the user interface program 20 must purchase the second crypto currency 800 enough to make up to the agreed generation charge determined by a ratio of the profit stated in the payment allocation investment agreement 223 used as the warranty to meet the warranty requirements, and then the smart contract 28 will continue.

On the other hand, if the user interface program 20 does not purchase the second crypto currency 800 enough to make up to the agreed generation charge determined by a ratio of the profit stated in the payment allocation investment agreement 223 used as the warranty, the smart contract 28 will be liquidated.

It should be noted that the second crypto currency 800 includes, but not limited to, a crypto currency issued by the information service provider of the present invention, which may also be a crypto currency already existing on the market, including, but not limited to, Bitcoin and Ethereum, Ripple, Litecoin, and so on.

The second crypto currency 800 may be a stable crypto currency with a stable price, such as a Tether USDT that follows the US dollar value or even a currency that follows the currency of other countries; or a volatile crypto currency with possible a price fluctuation, for example, the aforementioned Bitcoin, Ethereum, Ripple, Litecoin, and so on.

In addition, regarding the purchase of the second crypto currency 800, in more detail, the user interface program 20 can be connected to a vendor platform that provides the information service of the present invention, and purchases the crypto currency issued by the manufacturer and stores or temporarily stores a crypto currency wallet software unit stored on the user interface program 20.

Alternatively, the user interface program 20 may be connected to any particular crypto currency service provider, dealer, transaction center to purchase directly, or transfer the second crypto currency 800 that has already been purchased in advance. The purchased and stored or temporarily stored second 800 crypto currency in the crypto currency wallet software unit of the user interface program 20 can also be stored to the smart contract 28.

The smart contract 28 activates to enable the financial investment application program 22 and a smart trading gateway 26 in response to the authorization command 203 and completion of storing of the first crypto currency 600 or the storing of the second crypto currency 800 as the warranty.

When the smart contract 28 responds to the authorization command 203, that is, when the smart contract 28 receives the authorization command 203 and agrees to sign the contract with the user interface program 20, and the first crypto currency 600 or the second crypto currency 800 as the warranty meets the amount required for the contract is stored, the smart contract 28 will be launched to enable the financial investment application programs 22 and the smart trading gateway 26, i.e., start the financial investment application program 22 and the smart trading gateway 26.

The smart trading gateway 26 responds to a decision command 207 from the financial investment application program 22 of the generation end and uses the computer interface data 241 to interface with the one or more accounts opened at the financial instruments trading center 24, so as to issue an operation command 261 of financial commodity at the financial instruments trading center 24, and the smart trading gateway 26 can also receive financial investment performance data 243 transmitted by the financial instruments trading center 24 and can transmit financial investment performance data 243 to the smart contract 28.

It should be noted that the smart trading gateway 26 can interface with one or more investor accounts. When more than one investor account is connected, the financial investment application program 22 can execute more flexible operations on one or more investor accounts, including but not limited to arbitrage trading, hedging transactions, and so on.

Wherein, the smart trading gateway 26 can be regarded as a virtual agent program, which coexists with the financial investment application program 22, and the financial investment application program 22 must collaborate with the smart trading gateway 26 to safely and smoothly execute the financial investment transactions on the blockchain.

The role of the smart trading gateway 26 is similar to that of the channel. The computer interface data 241 of the account opened in the financial instruments trading center 24 will be stored here, and will not be stored in the financial investment application program 22. The purpose is for security control. If the computer interface data 241 of the investment end is stored in the financial investment application program, the financial investment application program 22 may be able to conduct fraud.

In other words, the financial investment application program 22 will only be responsible for the investment logic of the agent, similar to a brain center; and the smart trading gateway 26 is responsible for the execution of the order, data access and other actions.

It is worth noting that the collaboration also includes the combination of the financial investment application program 22 and the number of smart trading gateways 26. If a financial investment application program has 10 user interface programs 20 that want to entrust to invest in the operation, then the number of smart trading gates 26 must be 10; if there are 10 different financial investment application programs 22, and each financial investment application program 22 has 100 user interface programs 20 that want to entrust to invest in the operation, then the overall number of smart trading gateways 26 on the blockchain smart contract structure must be 1,000.

The smart contract 28 receives the financial investment performance data 243 transmitted by the smart trading gateway 26, regardless of the financial investment performance data 243, the smart contract 28 will disburse the first crypto currency 600 stored in the smart contract 28 to the financial investment application program of the generation end based on the fixed remuneration investment agreement 221 contracted between the user interface program 20 and the financial investment application program 22.

Or, the smart contract 28 receives the financial investment performance data 243 transmitted by the smart trading gateway 26, and, the smart contract 28 disburses a portion of the second crypto currency 800 stored in the smart contract 28 matching the financial investment performance data 243 to the financial investment application program 22 of the generation end based on the payment allocation investment agreement 223 contracted between the user interface program 20 and the financial investment application program 22.

The above describes the way of profit sharing between the investment end and the generation end. If the smart contract 28 between the user interface program 20 of the investment end and the financial investment application program 22 of the generation end is signed with a fixed remuneration investment agreement 221, regardless of the performance of the financial investment application program 22, the smart contract 28 will pay the first crypto currency 600 stored on the smart contract 28 to the financial investment application program 22 of the generation end according to the content of the smart contract 28 signed with the user interface program 20.

If the smart contract 28 between the user interface program 20 of the investment end and the financial investment application program 22 of the generation end is signed with a payment allocation investment agreement 223, the smart contract 28 will pay a ratio of the second crypto currency 800 stored on the smart contract 28 to the financial investment application program 22 of the generation end according to the content of the smart contract 28 signed with the user interface program 20 and according to the performance of the financial investment application program 22.

It is worth noting that the cloud host platform 8 can obtain an agreed portion of the first crypto currency 600 or the second crypto currency 800 obtained by the financial investment application program 22 through the financial investment application programs 22 on the shelf of the cloud host platform 8 as a profit (or service charge) of the information service provider implementing the method 1 of the present invention.

For example, if the financial investment application program 22 obtains the first crypto currency 600 equivalent to NT$500,000 as the agent's generation remuneration, the cloud host platform 8 is about to direct the financial investment application program 22 to extract 5% of the generation remuneration. As a profit, the financial investment application program 22 will allow the cloud host platform 8 to extract the first crypto currency 600 of the equivalent of NT$25,000 as a profit for implementing the method 1 of the present invention including the cloud host platform 8 as an information service provider.

In the same way, if the financial investment application program 22 obtains the second crypto currency 800 equivalent to NT$500,000 as the generation remuneration, the cloud host platform 8 is about to obtain 5% of the generation remuneration paid to the financial investment application program 22 by the user interface program 20. Therefore, the financial investment application program 22 will allow the cloud host platform 8 to extract the second crypto currency 800 equivalent to NT$25,000 as a profit for implementing the method 1 of the present invention including the cloud host platform 8 as an information service provider.

Since the financial investment performance data 243 transmitted by the smart contract 28 in response to the smart trading gateway 26 can be retransmitted to and displayed on the user interface program 20 for the investment end to consult, the investment end can use the financial investment performance data 243 at any time to make the user interface program 20 to generate and transmit a transaction liquidation command 205 to the smart contract 28 requesting the smart contract 28 to suspend the transaction for liquidation of the smart contract 28.

That is to say, the investment end can know the investment performance exhibited by the financial investment application program 22 so far through the user interface program 20, and can generate and transmit the transaction liquidation command 205 at any time to stop further trading or stop the loss.

FIG. 3 shows another schematic view of the financial investment application algorithm trading system 2 based on the blockchain smart contract of the present invention. FIG. 3 differs from FIG. 2 in that the system diagram showing that the financial investment application program only provides a fixed remuneration investment agreement, and the user interface program executes the fixed remuneration investment agreement displayed thereon. Other contents similar to those in FIG. 2 will not be repeated.

FIG. 4 shows yet another schematic view of the financial investment application algorithm trading system 2 based on the blockchain smart contract of the present invention. FIG. 4 differs from FIG. 2 in that the system diagram showing that the financial investment application program only provides a payment allocation investment agreement, and the user interface program executes the payment allocation investment agreement displayed thereon. Other contents similar to those in FIG. 2 will not be repeated.

It should be noted that the method 1 and the system 2 of the present invention are both based on the architecture of the blockchain smart contract, so all financial investment behaviors, agent activity, and profit sharings constructed in the method 1 and system 2 will be automated according to the contract content recorded on the smart contract 28. The trading terms of agreement of the contract can be immutable. All actions are also recorded in the blockchain for query, and will be traceable, immutable and irreversible, which will make the investment end the generation end always implement the distribution of benefits according to the smart contract 28, and effectively eliminate the risk of any party reluctant to follow the contract.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A financial investment application algorithm trading method based on a blockchain smart contract, applicable to a blockchain network executing the smart contract, comprising the following steps:
an investment end generates and transmits a selection command to a cloud host platform through a user interface program, and selects the financial investment application program stored on the cloud host platform, therewith selects a financial investment application program of a generation end stored in the cloud host platform, the selected financial investment application program, according to the selection command, transmits a fixed remuneration investment agreement and/or a profit-sharing investment agreement to a smart contract on a blockchain network, and the financial investment application program requests the smart contract to transmit the fixed remuneration investment agreement and/or the payment allocation investment agreement to the user interface program for displaying;
the user interface program executes the displayed fixed remuneration investment agreement or the payment allocation investment agreement, or executes one of the displayed fixed remuneration investment agreement and the payment allocation investment agreement, the user interface program transmit a corresponding authorization command generated after execution to the smart contract to achieve mutual assent between the user interface program and the smart contract;
the user interface program performs purchase of a first crypto currency matching a fixed remuneration generation charge stated in the fixed remuneration investment agreement according to the fixed remuneration generation charge stated in the fixed remuneration investment agreement, the user interface program stores the purchased first crypto currency to the smart contract to achieve provision of the fixed-investment investment agreement of the financial investment application program on the smart contract; the user interface program performs purchase of a second crypto currency matching a profit payment allocation generation charge stated in the payment allocation investment agreement as a warranty according to the profit payment allocation generation charge stated in the payment allocation investment agreement, the user interface program stores the second crypto currency purchased as the warranty to the smart contract to achieve provision of the payment allocation investment agreement of the financial investment application program on the smart contract;
the smart contract activates to enable the financial investment application program and a smart trading gateway in response to the authorization command and completion of storing of the first crypto currency or the storing of the second crypto currency as the warranty;
the user interface program transmits a computer interface data obtained from an account opened at a financial instruments trading center by the investment end to the smart trading gateway for storage;
the smart trading gateway responds to a decision command from the financial investment application program of the generation end and uses the computer interface data to interface with the account opened at the financial instruments trading center, so as to issue an operation command of financial commodity at the financial instruments trading center, and the smart trading gateway can also receive financial investment performance data transmitted by the financial instruments trading center and can transmit financial investment performance data to the smart contract; and
the smart contract receives the financial investment performance data transmitted by the smart trading gateway, regardless of the financial investment performance data, the smart contract will disburse the first crypto currency stored in the smart contract to the financial investment application program of the generation end based on the fixed remuneration investment agreement contracted between the user interface program and the financial investment application program; the smart contract receives the financial investment performance data transmitted by the smart trading gateway, and, the smart contract disburses a portion of the second crypto currency stored in the smart contract matching the financial investment performance data to the financial investment application program of the generation end based on the payment allocation investment agreement contracted between the user interface program and the financial investment application program.

2. The financial investment application algorithm trading method as claimed in claim 1, wherein the financial investment application program is an artificial intelligence (AI) program, experience logic program, transaction logic program, mathematical model based program or any combination thereof.

3. The financial investment application algorithm trading method as claimed in claim 1, wherein the computer interface data comprises an account data, a password data and/or a verification data used by application programming interface (API).

4. The financial investment application algorithm trading method as claimed in claim 1, wherein the cloud host platform can extract an agreed portion of the first crypto currency obtained by the financial investment application program; or the cloud host platform can extract an agreed portion of the second crypto currency obtained by the financial investment application program.

5. The financial investment application algorithm trading method as claimed in claim 1, wherein the financial instruments trading center is crypto currency trading centers, stock exchange centers, futures commodity trading centers, financial foreign exchange trading companies, commodity trading financial centers, real estate trading centers, movable property trading centers, derivative commodity trading centers or hedge commodity trading centers.

6. The financial investment application algorithm trading method as claimed in claim 1, wherein if the warranty stored on the smart contract is lower than the insurance level, the smart contract will transmit the warranty payment message to the user interface program, and the user interface program must purchase the second crypto currency enough to make up to the agreed generation charge determined by a ratio of the profit stated in the payment allocation investment agreement used as the warranty to meet the warranty requirements, and then the smart contract will continue; on the other hand, if the user interface program does not purchase the second crypto currency enough to make up to the agreed generation charge determined by a ratio of the profit stated in the payment allocation investment agreement used as the warranty, the smart contract will be liquidated.

7. The financial investment application algorithm trading method as claimed in claim 1, wherein the financial investment performance data transmitted by the smart contract in response to the smart trading gateway can be retransmitted to and displayed on the user interface program for the investment end to consult, and the investment end can use the financial investment performance data at any time to make the user interface program to generate and transmit a transaction liquidation command to the smart contract requesting the smart contract to suspend the transaction for liquidation of the smart contract.

8. The financial investment application algorithm trading method as claimed in claim 1, wherein the first crypto currency may be a stable crypto currency with a stable price, or a volatile crypto currency with possible a price fluctuation; the second crypto currency may be a stable crypto currency with a stable price, or a volatile crypto currency with possible a price fluctuation.

9. A financial investment application algorithm trading system based on a blockchain smart contract, applicable to a blockchain network executing the smart contract, comprising:
an investment end, comprising a user interface program;
a generation end, comprising a financial investment application program, and the financial investment application program being stored in a cloud host platform;
a financial instrument trading center;
a smart trading gateway, storing a computer interface data obtained by an account opened by the user interface program in the financial instruments trading center transmitted from the user interface program of the investment end; and
a smart contract, written with a fixed remuneration investment agreement and/or a payment allocation investment agreement recorded in the financial investment application program;
wherein, the investment end generates and transmits a selection commands to a cloud host platform through the user interface program, and selects the financial investment application program stored on the cloud host platform, therewith selects the financial investment application program of the generation end stored in the cloud host platform, the selected financial investment application program, according to the selection command, transmits the fixed remuneration investment agreement and/or the payment allocation investment agreement to the smart contract on a blockchain network, and the financial investment application program requests the smart contract to transmit the fixed remuneration investment agreement and/or the payment allocation investment agreement to the user interface program for displaying; the user interface program executes the displayed fixed remuneration investment agreement or the payment allocation investment agreement, or executes one of the displayed fixed remuneration investment agreement and the payment allocation investment agreement, the user interface program transmit a corresponding authorization command generated after execution to the smart contract to achieve mutual assent between the user interface program and the smart contract; the user interface program performs purchase of a first crypto currency matching a fixed remuneration generation charge stated in the fixed remuneration investment agreement according to the fixed remuneration generation charge stated in the fixed remuneration investment agreement, the user interface program stores the purchased first crypto currency to the smart contract to achieve provision of the fixed-investment investment agreement of the financial investment application program on the smart contract; the user interface program performs purchase of a second crypto currency matching a profit payment allocation generation charge stated in the payment allocation investment agreement as a warranty according to the profit payment allocation generation charge stated in the payment allocation investment agreement, the user interface program stores the second crypto currency purchased as the warranty to the smart contract to achieve provision of the payment allocation investment agreement of the financial investment application program on the smart contract; the smart contract activates to enable the financial investment application program and the smart trading gateway in response to the authorization command and completion of storing of the first crypto currency or the storing of the second crypto currency as the warranty; the user interface program transmits the computer interface data obtained from the account opened at the financial instruments trading center by the investment end to the smart trading gateway for storage; the smart trading gateway responds to a decision command from the financial investment application program of the generation end and uses the computer interface data stored therein to interface with the account opened at the financial instruments trading center, so as to issue an operation command of financial commodity at the financial instruments trading center, and the smart trading gateway can also receive financial investment performance data transmitted by the financial instruments trading center and can transmit financial investment performance data to the smart contract; and the smart contract receives the financial investment performance data transmitted by the smart trading gateway, regardless of the financial investment performance data, the smart contract will disburse the first crypto currency stored in the smart contract to the financial investment application program of the generation end based on the fixed remuneration investment agreement contracted between the user interface program and the financial investment application program; the smart contract receives the financial investment performance data transmitted by the smart trading gateway, and, the smart contract disburses a portion of the second crypto currency stored in the smart contract matching the financial investment performance data to the financial investment application program of the generation end based on the payment allocation investment agreement contracted between the user interface program and the financial investment application program.

10. The financial investment application algorithm trading system as claimed in claim 9, wherein the financial investment application program is an artificial intelligence (AI) program, an experience logic program, a transaction logic program, a mathematical model based program, or any combination thereof.

11. The financial investment application algorithm trading system as claimed in claim 9, wherein the computer interface data comprises an account data, a password data and/or a verification data used by application programming interface (API).

12. The financial investment application algorithm trading system as claimed in claim 9, wherein the cloud host platform can extract an agreed portion of the first crypto currency obtained by the financial investment application program; or the cloud host platform can extract an agreed portion of the second crypto currency obtained by the financial investment application program.

13. The financial investment application algorithm trading system as claimed in claim 9, wherein the financial instruments trading center is crypto currency trading centers, stock exchange centers, futures commodity trading centers, financial foreign exchange trading companies, commodity trading financial centers, real estate trading centers, movable property trading centers, derivative commodity trading centers or hedge commodity trading centers.

14. The financial investment application algorithm trading system as claimed in claim 9, wherein if the warranty stored on the smart contract is lower than the insurance level, the smart contract will transmit the warranty payment message to the user interface program, and the user interface program must purchase the second crypto currency enough to make up to the agreed generation charge determined by a ratio of the profit stated in the payment allocation investment agreement used as the warranty to meet the warranty requirements, and then the smart contract will continue; on the other hand, if the user interface program does not purchase the second crypto currency enough to make up to the agreed generation charge determined by a ratio of the profit stated in the payment allocation investment agreement used as the warranty, the smart contract will be liquidated.

15. The financial investment application algorithm trading system as claimed in claim 9, wherein the financial investment performance data transmitted by the smart contract in response to the smart trading gateway can be retransmitted to and displayed on the user interface program for the investment end to consult, and the investment end can use the financial investment performance data at any time to make the user interface program to generate and transmit a transaction liquidation command to the smart contract requesting the smart contract to suspend the transaction for liquidation of the smart contract.

16. The financial investment application algorithm trading system as claimed in claim 9, wherein the first crypto currency may be a stable crypto currency with a stable price, or a volatile crypto currency with possible a price fluctuation; the second crypto currency may be a stable crypto currency with a stable price, or a volatile crypto currency with possible a price fluctuation.
